(19) United States
(12) Patent Application Publication
(10) Pub. No.: US 2022/0089029 A1
(43) Pub. Date: Mar. 24, 2022

(54) INFOTAINMENT DEVICE FOR A VEHICLE

(71) Applicant: PSA AUTOMOBILES SA, Poissy (FR)

(72) Inventors: Nicolas FOUQUEREAU, FONTENAY LES BRIIS (FR); Begona MARTINEZ LOPEZ, COURBEVOIE (FR); Raphael DRAP, RAMBOUILLET (FR); Laurent NICOLAS, PUTEAUX (FR); Saran DIAKITE KABA, BIEVRES (FR); Valentin CAZIN, PARIS (FR); Clement FILIPPI, BOULOGNE BILLANCOURT (FR); Eric LOSEGO, SAINT CYR L'ECOLE (FR)

(21) Appl. No.: 17/438,815

(22) PCT Filed: Feb. 19, 2020
(86) PCT No.: PCT/FR2020/050307

§ 371 Date: Sep. 13, 2021

(30) Foreign Application Priority Data
Mar. 22, 2019 (FR) 1903025

(51) Int. Cl. B60K 37/06

(52) U.S. Cl. CPC B60K 37/06; B60K 2370/149; B60K 2370/21; B60K 2370/197; B60K 2370/164

(57) ABSTRACT

Infotainment device for a vehicle, comprising:
computing means,
detection means designed to distinguish a situation in which the vehicle is driving from a situation in which the vehicle is stationary, and connected to the computing means,
input means connected to the computing means and allowing user information to be input according to:
   a first input mode requiring visual contact with the input means for a period longer than two seconds,
   a second input mode requiring visual contact with the input means for a period shorter than or equal to two seconds,
      characterized in that the computing means are configured to offer only the second input mode when the vehicle is in a driving situation.

### CROSS-REFERENCE TO RELATED APPLICATIONS

This application is the US National Stage under 35 USC § 371 of International Application No. PCT/FR2020/050307, filed 19 Feb. 2020 which claims priority to French Application No. 1903025 filed 22 Mar. 2019, both of which are incorporated herein by reference.

### BACKGROUND

The present invention relates generally to an infotainment device mounted on a motor vehicle.

### TECHNICAL FIELD

Motor vehicles are generally equipped with an infotainment device making it possible to control comfort functions such as the air conditioning system or the audio-video system. It also provides access to information on the state of the vehicle as well as navigation information.

### PRIOR ART

Infotainment devices are known in the prior art, as illustrated by FR3033074B1. However, this system may have the particular drawback of requiring prolonged visual contact from the user, for example to enter information or navigate the menus. Furthermore, such an infotainment system can display unwanted entertainment information while driving the vehicle due to the distraction it causes.

### SUMMARY

One aim of the present disclosed device is to address the drawbacks of the device disclosed in the prior art document mentioned above and in particular, first of all, to reduce the level of distraction of a driver of the vehicle during a driving operation of the vehicle.

To this end, a first aspect relates to an infotainment device for a vehicle, comprising:
computing means,
detection means designed to distinguish a situation in which the vehicle is driving from a situation in which the vehicle is stationary, and connected to the computing means,
input means connected to the computing means and allowing user information to be input according to:
a first input mode requiring visual contact with the input means for a period longer than two seconds,
a second input mode requiring visual contact with the input means for a period shorter than or equal to two seconds,
wherein the computing means is configured to offer only the second input mode when the vehicle is in a driving situation.

In this way, the infotainment system makes it possible to limit the distraction of the driver and therefore to improve the safety of a driving operation of the vehicle.

Advantageously, in a driving situation of the vehicle, the computing means is configured to launch a verification step making it possible to verify that the user is not the driver of the vehicle and then to offer both the first input mode and the second input mode.

For example, this verification step can be launched when a user tries to access the first input mode.

Thus, a passenger can easily use the infotainment system owing to all the possible input modes, thus making it possible to relieve the driver of distracting tasks related to the infotainment system. For example, this verification step may comprise a specific button to be actuated and/or may involve detection means making it possible to ensure that the infotainment system is not being manipulated by the driver.

By way of example, the input means comprises a keyboard and/or buttons that can be used in the first input mode as well as a voice recognition module, a gesture recognition module and/or a handwriting recognition module which are usable in the second input mode.

Advantageously, the present infotainment system further comprises display means and the input means comprises a touch detection layer integrated into the display means, for example in the form of a touchscreen.

Alternatively or in combination, the computing means is configured to display, on the display means:
first entertainment information unrelated to the vehicle,
second comfort and/or navigation information related to the vehicle,
third information whose display is required for legal and/or safety reasons,
wherein the computing means is configured to display only the second and third information when the vehicle is in a driving situation.

Thus, the most distracting information that is not useful for driving the vehicle is not displayed during a driving situation, so as to further limit the distraction of the driver.

Alternatively or in combination, the computing means is configured to offer:
first functions requiring a period of longer than fifteen seconds for a user to implement, and
second functions requiring a period of shorter than or equal to fifteen seconds for the user to implement,
and the computing means is configured to offer only the second functions when the vehicle is in a driving situation.

Thus, the driver cannot initiate or use complex functions of the infotainment system that could cause significant distraction.

Advantageously, third functions corresponding to the first functions adapted so as to impose an implementation for a period shorter than or equal to fifteen seconds on the user are offered when the vehicle is in a driving situation. The driver can therefore have access to more functions than just the second functions, while limiting the distraction caused by these functions.

In a second aspect a security method is provided for a vehicle comprising the infotainment system described above according. The method comprises at least the steps of:
distinguishing, by the detection means, a situation in which the vehicle is driving from a situation in which the vehicle is stationary,
offering a first input mode requiring the user to have visual contact with the input means for a period longer than two seconds and a second input mode requiring the user to have visual contact with the input means for a period shorter than or equal to two seconds, in a situation where the vehicle is stationary,
offering only the second input mode when the vehicle is in a driving situation.

In addition, the present method can comprise a verification step as well as steps related to the first and second functions and/or to the first, second and third information, as described previously in the first aspect.

A final aspect relates to a motor vehicle comprising an infotainment system according to the first aspect and/or which implements the security method according to the second aspect.

### DESCRIPTION OF THE DRAWINGS

Other features and advantages will emerge more clearly on reading the following detailed description given by way of non-limiting example and illustrated by the appended drawings, in which:

FIG. 1 shows an example of a user interface accessible on an infotainment device, and

FIG. 2 shows another example of a user interface accessible on the infotainment device.

### DETAILED DESCRIPTION

The present device is applicable in any type of vehicle, whether personal, collective, agricultural, military or industrial. The general object is to limit the distraction of the driver when driving the vehicle, thus allowing him to concentrate on the traffic and the driving operation.

An infotainment device comprises computing means, detection means, input means, as well as display means on board the vehicle.

The computing means comprises one or more microprocessors and memory units making it possible to implement one or more computer programs.

The detection means is connected to the computing means by a wired or possibly wireless connection. They make it possible to distinguish a situation in which the vehicle is driving from a situation in which the vehicle is stationary and comprise, for example, a speed sensor, an accelerometer or a satellite positioning sensor.

A situation in which the vehicle is stationary is for example a situation in which the vehicle is stopped or a situation in which the vehicle is traveling at very low speed, for example less than 5 km/h or less than 3 km/h. Depending on local law, a situation in which the vehicle is stationary may be a situation in which the vehicle is stopped outside of a traffic lane, for example parked in a parking space.

A situation in which the vehicle is driving is a situation in which the vehicle is moving, for example with a non-zero speed, greater than 3 km/h or even greater than 5 km/h. Depending on local law, it may also be a situation where the vehicle is positioned in a traffic lane, including when stationary.

The input means can comprise any type of input means known to those skilled in the art, for example a keyboard or physical or virtual buttons, a voice recognition module, a gesture recognition module or a handwriting recognition module.

The display means can comprise any type of screen or projection system, for example on a dashboard or on a vehicle windshield. For example, this may be a screen having a tactile detection layer making it possible to integrate input means in the form of a keyboard or virtual buttons and/or a handwriting recognition module.

The input means can offer at least two different input modes:
a first input mode requiring visual contact with the input means for a period longer than two seconds, for example through a keyboard or virtual buttons which require looking at the screen, and
a second input mode requiring visual contact with the input means for a period shorter than or equal to two seconds, for example a voice recognition module that can be triggered by a virtual button.

Finally, the computing means can offer, for example by displaying a user interface on the display means, two types of functions:
first functions requiring a period longer than fifteen seconds for a user to implement, for example, selecting a recipient from a list of recipients, accessing the settings of the infotainment system or performing a first pairing of the infotainment system with a mobile device, and
second functions requiring a period shorter than or equal to fifteen seconds for a user to implement, for example selecting navigation to a pre-recorded destination, selecting a radio station to listen to or selecting a specific display mode of the display means from pre-recorded display modes.

Finally, the computing means can be configured to display on the display means:
first entertainment information unrelated to the vehicle, for example an online video or a video game,
second comfort and/or navigation information related to the vehicle, for example satellite navigation or air conditioning or heating settings, and
third information, the display of which is required for legal and/or safety reasons, for example a legal disclaimer related to the use of the navigation system or a low tire pressure signal.

A safety method which can be implemented by the computing means comprises a step of detecting a situation in which the vehicle is driving or a situation in which the vehicle is stationary. For example, this step can be carried out by the computing means based on information sent by the detection means.

In a situation where the vehicle is stationary, the computing means gives access to all the input modes allowed by the input means, all the displayable information and all the functions available on the infotainment system. In other words, a user of the infotainment system has access to the entire infotainment system of the vehicle.

However, if a driving situation is detected, the computing means can switch the infotainment system to a simplified mode.

In this simplified mode, only the second input mode requiring visual contact with the input means lasting at most two seconds is offered to the user. For example, it may be a voice recognition mode or a handwriting recognition mode that can be activated by pressing dedicated buttons. The driver can therefore activate the input mode and enter his input without looking away from the traffic, for example by speaking or else by drawing letters blindly on a touch-sensitive surface that may or may not be integrated into the display means.

The duration of visual contact imposed by each input mode on the user can be measured simply according to methods known to those skilled in the art, for example by oculometry and/or according to standard protocols in force in the industry, for example the NHTSA protocol.

The availability of only the second input mode in a driving situation prevents the driver of the vehicle from having his attention diverted from traffic to the infotainment system. This limits or prevents dangerous situations in which the driver is not focused on driving his vehicle.

In addition, a verification step can be provided, for example by a dedicated “Passenger” button that can be displayed on the display means, in order to verify that the user of the infotainment system is not the driver of the vehicle. If this verification is successful, that is to say, if the user confirms that he is a passenger in the vehicle and not the driver, then full access to the input means is authorized, for example access to the first input mode. For example, input means can comprise seat sensors and this verification step can be offered only when a passenger is seated in the front passenger seat of the vehicle.

Alternatively or in combination, the verification means may comprise a camera for acquiring an image of the interior of the vehicle so as to determine whether a front passenger is present and/or whether the infotainment system is being operated by the front passenger and not by the driver of the vehicle. In addition, the verification means can comprise steering wheel sensors making it possible to verify that the driver indeed has his hands on the steering wheel, and therefore that the infotainment system is being used by a passenger of the vehicle.

In addition, the computing means may not offer or block the first functions imposing an implementation lasting longer than fifteen seconds on a user. This implementation period can also be measured according to methods and protocols known to those skilled in the art and can correspond to the average time required to perform the function by a test population of drivers.

These first functions typically comprise functions that are long or complex to implement, for example functions for configuring the infotainment system, and only the second functions, which are faster to implement, may be available in the context of a vehicle driving situation. These second functions may correspond to the use of basic functions, for example the adjustment of the air conditioning system.

Thus, the driver cannot access the most complex functions of the infotainment system in a driving situation, which limits his distraction and therefore the dangerous situations associated with it. For example, a verification step as described above can also provide access to the first functions to a passenger of the vehicle.

Optionally, simplified third functions can be offered in a driving situation instead of the first functions. For example, these may be certain settings among all the possible settings, or even a choice of recipient of a telephone call which is possible only among favorite and/or recent recipients. These third functions are therefore designed in such a way as to allow limited access to the first functions so that their implementation takes fifteen seconds or less for the user.

In this way, the driver can have access to certain complex functions of the infotainment system while limiting his distraction.

Finally, the computing means can be configured so that only the second and third information is available in a driving situation. For example, a mask can be applied to the first information in a driving situation.

A verification step as described above is possible, but not desirable, since it is difficult to offer information to a front passenger without it being accessible to the driver. However, the display means can comprise display devices that are not visible to the driver, for example dedicated to rear passengers, and the first information can be offered only on these display devices.

Thus, the driver cannot be distracted by entertainment information which is unrelated to the driving of the vehicle, which encourages him to concentrate on driving the vehicle and on the traffic conditions.

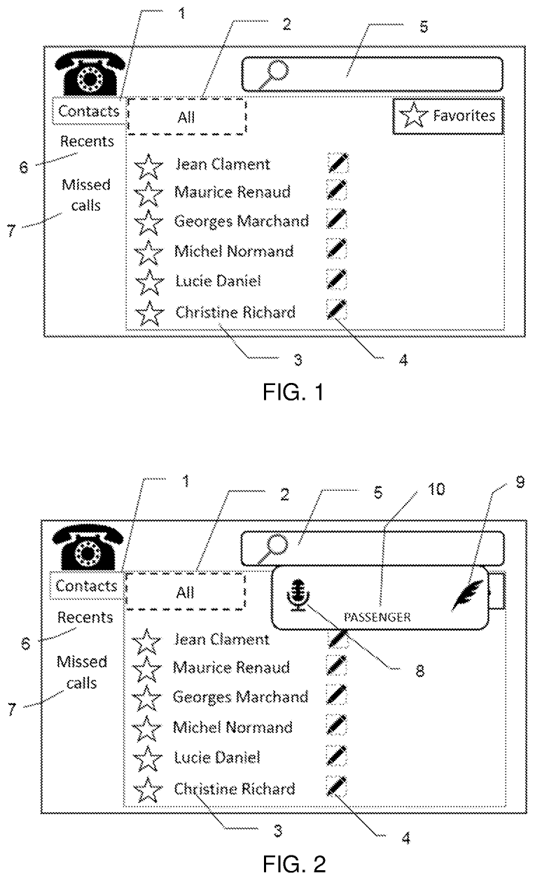

FIG. 1 shows an interface of an infotainment system generated by the computing means as shown on the display means and allowing telephone calls to be made, for example by a wireless connection with a mobile telephone.

With the vehicle in a driving situation, the “Contacts” menu 1 does not provide access to all the contacts and the “All” button 2 is dotted or grayed out to indicate that these first functions are not available. Conversely, access is possible only to the favorite contacts 3 according to a third function, thus limiting the setup period of a telephone call. According to another possible first function, it is also not possible to edit these favorite contacts 3 in a driving situation, as shown by editing icons 4 which are dotted or grayed out.

In FIG. 1, the “Recent” button 6 providing access to recent calls and “Missed calls” button 7 providing access to unanswered calls relate to the second functions requiring an implementation period shorter than or equal to fifteen seconds and are accessible to the user.

If the user presses the dotted or grayed out buttons corresponding to all the contacts (button 2) or “edit” (button 4), a window may mention that this function is disabled for safety reasons and/or may propose a verification step allowing a passenger to access these first functions which are unavailable to the driver.

In addition, a search field 5 is available. In FIG. 2, the user has pressed on the search field 5 and instead of the first input mode comprising a touch keyboard, touch-sensitive buttons 8 and 9 each correspond to a second input mode are displayed, namely, voice recognition and handwriting recognition, respectively. In addition, a “PASSENGER” button 10 provides access to the step for verifying the identity of the user, and if the user confirms or is verified as a passenger, then a touch-sensitive keyboard according to a first input mode is made available.

It will be understood that various modifications and/or improvements obvious to a person skilled in the art can be made to the claimed invention described in the present description without departing from the scope of the claimed invention. In particular, reference is made to the duration of the user's visual contact with the input means, which is not limited to two seconds, but may comprise any acceptable duration according to the culture and laws of a country or a geographical area, for example one second or three seconds.

In addition, the implementation period of the first and second functions is not limited to fifteen seconds, but can be adapted according to laws or local customs, for example, ten, twelve, eighteen or twenty seconds.

1. An infotainment device for a vehicle, comprising:
computing means,
detection means adapted to distinguish a situation in which the vehicle is driving from a situation in which the vehicle is stationary, and connected to the computing means,
input means connected to the computing means and adapted to allow user information to be input according to:
a first input mode requiring visual contact with the input means for a period longer than two seconds,
a second input mode requiring visual contact with the input means for a period shorter than or equal to two seconds,
wherein the computing means is configured to offer only the second input mode when the vehicle is in a driving situation.

2. The infotainment device according to claim 1, wherein in a driving situation of the vehicle, the computing means is configured to launch a verification step making it possible to verify that the user is not the driver of the vehicle and then to offer both the first input mode and the second input mode.

3. The infotainment device according to claim 1, wherein the input means comprises a keyboard and/or buttons that can be used in the first input mode as well as a voice recognition module, a gesture recognition module and/or a handwriting recognition module which are usable in the second input mode.

4. The infotainment device according to claim 3, wherein the infotainment device further comprises display means, wherein and in that the input means comprises a touch detection layer integrated into the display means.

5. The infotainment device according to claim 4, wherein the computing means is configured to display, on the display means:
first entertainment information unrelated to the vehicle, and
second comfort and/or navigation information related to the vehicle,
third information whose display is required for legal and/or safety reasons,
wherein the computing means is configured to display only the second and third information when the vehicle is in a driving situation.

6. The infotainment device according to claim 1, wherein the computing means is configured to offer:
first functions requiring a period of longer than fifteen seconds for a user to implement, and
second functions requiring a period of shorter than or equal to fifteen seconds for the user to implement,
wherein the computing means is configured to offer only the second functions when the vehicle is in a driving situation.

7. The infotainment device according to claim 6, wherein third functions corresponding to the first functions adapted so as to impose an implementation for a period shorter than or equal to fifteen seconds on the user are offered when the vehicle is in a driving situation.

8. A safety method for a vehicle comprising an infotainment system according to claim 1, said safety method comprising at least the steps of:
distinguishing, by the detection means, a situation in which the vehicle is driving from a situation in which the vehicle is stationary,
offering a first input mode requiring visual contact with the input means for a period longer than two seconds and a second input mode requiring visual contact with the input means for a period shorter than or equal to two seconds, in a situation where the vehicle is stationary,
offering only the second input mode when the vehicle is in a driving situation.

9. A motor vehicle comprising an infotainment device according to claim 1.
